(19) United States
(12) Patent Application Publication
(10) Pub. No.: US 2024/0403116 A1
(43) Pub. Date: Dec. 5, 2024

(54) METHOD AND DEVICE FOR OPTIMIZING AUGMENTED REALITY SERVICE PERFORMANCE

(71) Applicant: SAMSUNG ELECTRONICS CO., LTD., Suwon-si (KR)

(72) Inventors: Joongseob KIM, Suwon-si (KR); Jongheun YOO, Suwon-si (KR)

(21) Appl. No.: 18/804,739

(22) Filed: Aug. 14, 2024

Related U.S. Application Data
(63) Continuation of application No. PCT/KR2023/002432, filed on Feb. 21, 2023.

(30) Foreign Application Priority Data
Feb. 21, 2022 (KR) 10-2022-0022494
Mar. 21, 2022 (KR) 10-2022-0034729

(51) Int. Cl. G06F 9/48

(52) U.S. Cl. CPC G06F 9/4881

(57) ABSTRACT

An electronic device according to various embodiments may comprise: a communication module comprising communication circuitry and at least one processor, comprising processing circuitry, wherein at least one processor, individually and/or collectively, is configured to: based on making a connection to an augmented reality (AR) device through the communication module to provide an augmented reality service, receive a basic performance preset including configuration parameters related to AR tasks and a load balancing policy between devices; perform load balancing between devices so that the AR device and the electronic device distribute and process the AR tasks according to a processing subject of each AR task based on the basic performance preset; based on a change condition for load balancing between devices occurring in at least one of the AR tasks being processed in the AR device, reconfigure a first AR task, for which the change condition has occurred, among the AR tasks being processed in the AR device, so that the first AR task is switched and processed in the electronic device; and receive data related to the first AR task from the AR device and process the data.

### CROSS-REFERENCE TO RELATED APPLICATIONS

This application is a continuation of International Application No. PCT/KR2023/002432 designating the United States, filed on Feb. 21, 2023, in the Korean Intellectual Property Receiving Office and claiming priority to Korean Patent Application Nos. 10-2022-0022494, filed on Feb. 21, 2022, and 10-2022-0034729, filed on Mar. 21, 2022, in the Korean Intellectual Property Office, the disclosures of each of which are incorporated by reference herein in their entireties.

### BACKGROUND

### Field

The disclosure relates to a method and a device for optimizing the performance of an augmented reality service.

### Description of Related Art

Recently, there have been increasing demands for electronic devices supporting augmented reality (AR) or mixed reality (MR) services which provide information by superimposing virtual images on backgrounds or on images of real-world elements.

As next-generation immersive media devices supporting AR services (hereinafter, referred to as AR devices), wearable electronic devices which can be worn on human bodies (for example, head-mounted devices, head-mounted displays, or AR glasses) have been developed. AR devices are attracting increasing attention in line with developing communication technologies which enable large-capacity data transmission, such as 5G communication.

AR services require heavy-load computational jobs such as real-time tracking, image processing and rendering by AR devices and electronic devices (for example, host devices or controller devices). Due to such jobs, AR devices have problems resulting from heating and increased power consumption during AR services.

In order to address the problem related to heating or increased power consumption occurring during AR services, a scheme in which the CPU clock rate of AR devices is adjusted, or the display of AR devices is turned off (hereinafter, referred to as AR device control scheme) may be used.

However, such an AR device control scheme fails to dynamically reflect various dynamic environments of AR devices, electronic devices, AR apps, and users. If the display of an AR device is turned off due to limitations of the AR device, the user may be forced experience abrupt interruption of the AR service.

In addition, the AR device control scheme fails to consider the performance of electronic devices (for example, host devices or controller devices) connected to AR devices and AR apps installed in the electronic devices, and efficient resource distribution between the electronic devices and AR devices may thus be difficult.

### SUMMARY

Embodiments of the disclosure may provide an optimization scheme capable of resolving an issue related to heating and power consumption of AR devices and electronic devices and maximizing/improving the efficiency of device resources.

An electronic device according to various example embodiments may comprise a communication module comprising communication circuitry and at least one processor, comprising processing circuitry, wherein at least one processor, individually and/or collectively, is configured to: based on making a connection to an augmented reality (AR) device through the communication module to provide an augmented reality service, receiving a basic performance set including configuration parameters related to AR tasks and a load balancing policy between devices; perform load balancing between devices so that the AR device and the electronic device distribute and process the AR tasks according to a processing subject of each AR task based on the basic performance set; based on a change condition for load balancing between devices occurring in at least one of the AR tasks being processed in the AR device, reconfigure a first AR task, for which the change condition has occurred, among the AR tasks being processed in the AR device, so that the first AR task is switched and processed in the electronic device; and receive data related to the first AR task from the AR device and process the data.

A method for optimizing an augmented reality service by an electronic device according to various embodiments may comprise: connecting to an augmented reality (AR) device, receiving a basic performance set comprising an inter-device load balancing policy and a configuration parameter related to AR jobs based on providing an AR service by connecting to the AR device, performing inter-device load balancing such that the AR jobs are processed in a distributed manner in the AR device and the electronic device according to processing entities of respective AR jobs, based on the basic performance set, based on an inter-device load balancing changing condition occurring to one of AR jobs currently processed in the AR device, reconfiguring a first AR job to which the changing condition occurred, among the AR jobs currently processed in the AR device, so as to be switched and processed in the electronic device, and receiving data related to the first AR job from the AR device and process the data.

According to various example embodiments, an optimal performance preset (or personalized performance preset which may also be referred to as a set) may be implemented by analyzing characteristics according to the performance of AR devices, performance of electronic devices, performance of AR apps, and user environments, performance optimization may be performed through load balancing between AR devices and electronic devices, and resource efficiency of respective devices may be improved.

According to various example embodiments, a performance optimization policy may be generated and generated while interworking with a server device, based on pieces of data collected in various environments, thereby improving product performance management by the device manufacturer and better handling issues occurring in the market.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an electronic device according to various embodiments;

FIG. 3 is a diagram illustrating an example scheme for optimizing the performance of an AR service by an electronic device according to various embodiments;

FIG. 4 is a flowchart illustrating an example method for optimizing the performance of an AR service by an electronic device according to various embodiments;

FIG. 5 is a diagram illustrating example device load balancing operations of an electronic device and an AR device according to various embodiments;

FIG. 6 is a diagram illustrating an example configuration of a system including an electronic device, an AR device, and a server according to various embodiments;

FIG. 7 is a diagram illustrating an example configuration of a system including an electronic device, an AR device, and a server according to various embodiments;

FIG. 8A and FIG. 8B are flowcharts illustrating an example method for optimizing an AR service by an electronic device and a server device according to various embodiments; and

FIG. 9 is a flowchart illustrating an example personalized performance preset tuning method according to various embodiments.

### DETAILED DESCRIPTION

The electronic device according to various example embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

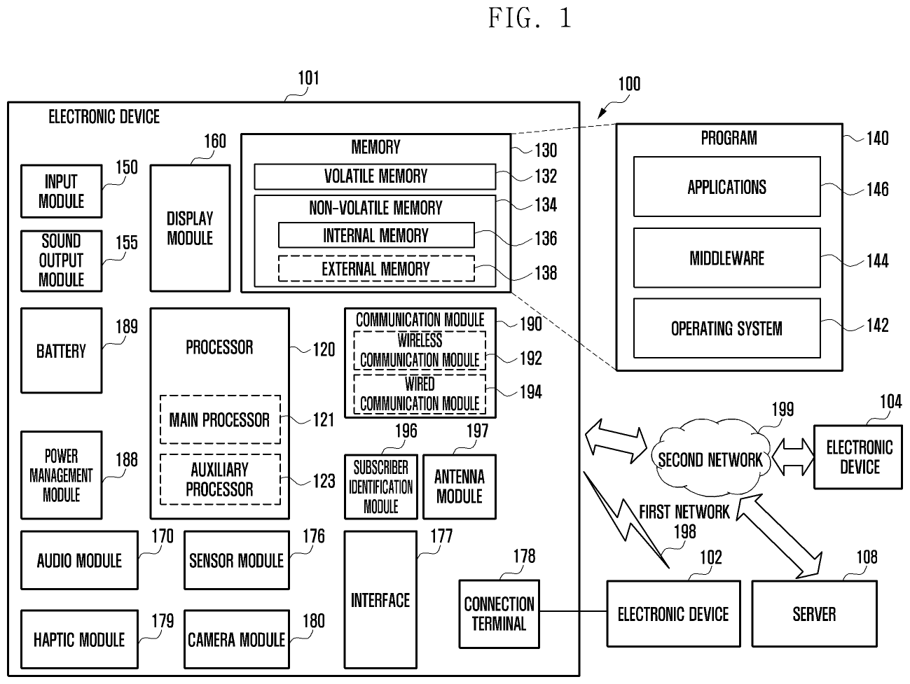

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input 1module 150, a sound output module 155, a display 1module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the 11connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display 1module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input 1module 150 may receive a command or data to be used by another component (e.g., the processor 120) of the electronic device 101, from the outside (e.g., a user) of the electronic device 101. The input 1module 150 may include, for example, a microphone, a mouse, a keyboard, a key (e.g., a button), or a digital pen (e.g., a stylus pen).

The sound output 1module 155 may output sound signals to the outside of the electronic device 101. The sound output 1module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 1module 160 may include, for example, a display, a hologram device, or a projector and control circuitry to control a corresponding one of the display, hologram device, and projector. According to an embodiment, the display 1module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input 1module 150, or output the sound via the sound output 1module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

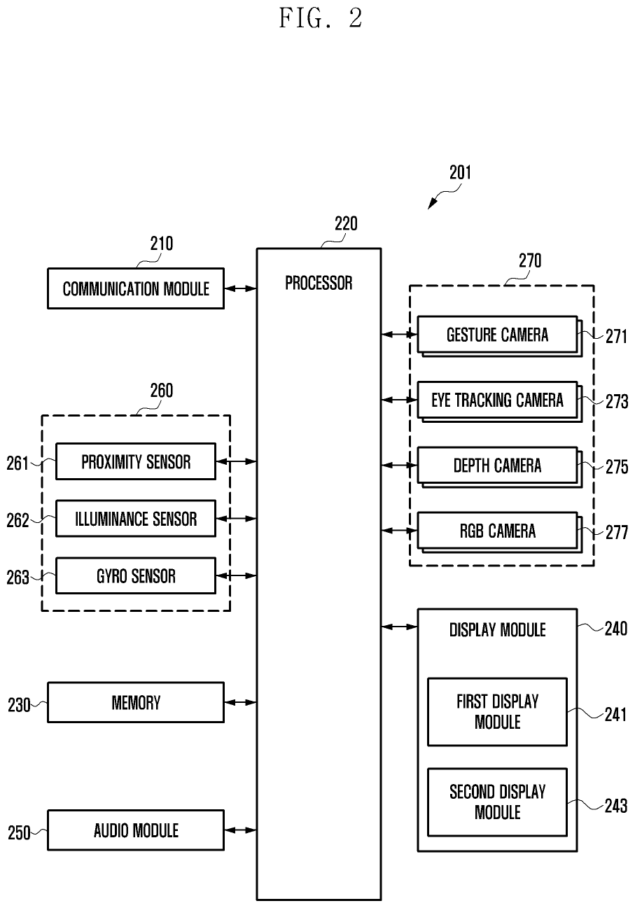

FIG. 2 is a block diagram illustrating an example configuration of an electronic device according to various embodiments.

Referring to FIG. 2, according to various embodiments, an augmented reality (AR) device 201 configured to provide images related to an AR service to a user may be configured as at least one of glasses, goggles, a helmet, or a hat, but is not limited thereto. For example, the AR device 201 may be a head-mounted device (HMD), a head-mounted display (HMD), or AR glasses.

The AR device 201 may provide an AR service by interworking with an electronic device (or a host device/controller device) (for example, the electronic device 101 in FIG. 1).

The AR device 201 may provide an AR service such that at least one virtual object is output so as to appear superimposed in an area deemed to be the user's field of view (FoV). For example, the area deemed to be the user's FoV may be an area deemed to be recognizable by the user through the AR device 201, and may include all or at least a part of the display module 240 of the AR device 201.

According to an embodiment, the AR device 201 may be at least partially controlled by an electronic device (for example, the electronic device 101 in FIG. 1) such that at least one function is performed under the control of the electronic device (for example, the electronic device 101 in FIG. 1).

According to an embodiment, the AR device 201 may include a communication module (e.g., including communication circuitry) 210, a processor (e.g., including processing circuitry) 220, a memory 230, a display module (e.g., including a display) 240, an audio module (e.g., including audio circuitry) 250, a sensor module (e.g., including at least one sensor) 260, and a camera module (e.g., including at least one camera) 270. Although not illustrated in the drawings, the AR device 201 may further include a power management module and a battery.

According to an embodiment, the communication module 210 (for example, a wireless communication circuit) may include various communication circuitry and perform communication with an electronic device (for example, the electronic device 101 in FIG. 1) through a wireless communication network (for example, the first network 198 (for example, a short-range wireless communication network) in FIG. 1) or may perform wireless communication with a server device through a long-distance wireless network (for example, the network 199 in FIG. 1). For example, the AR device 201 may perform wireless communication with an electronic device (for example, the electronic device 101 in FIG. 1) so as to exchange instructions and/or data with each other.

According to an embodiment, the communication module 210 may support 5G networks beyond 4G networks and next-generation communication technology, for example, new radio (NR) access technology. The NR access technology may support high-speed transmission of large-capacity data (enhanced mobile broadband (eMBB)), UE power minimization/reduction and multi-UE access (massive machine type communications (mMTC)), or high reliability and low latency (ultra-reliable and low-latency communications (URLLC)). The communication module 210 may support a high-frequency band (for example, mmWave band) in order to accomplish a high data transmission rate, for example. The communication module 210 may support various technologies for securing performance in a high-frequency band, for example, technologies such as beamforming, massive multiple-input and multiple-output (MIMO), full dimensional MIMO (FD-MIMO), array antennas, analog beamforming, or large-scale antennas.

According to an embodiment, the display module 240 may include at least one display and display at least one virtual object on at least a part of the display panel such that virtual objects appear superimposed on images related to actual spaces acquired through the camera module 270 by the user wearing the AR device 201.

According to various embodiments, the display module 240 may include a first display module 241 corresponding to the left eye among the user's both eyes and/or a second display module 243 corresponding to the user's right eye.

According to an embodiment, the display module 240 may be configured as a transparent or semi-transparent display.

According to an embodiment, the display module 240 may include a lens. The lens may include a lens including a transparent waveguide. The lens may transfer light output by the display panel to the user's eyes. For example, light emitted by the display panel may pass through the lens and may be transferred to the user through a waveguide formed in the lens. The waveguide may include at least one from among at least one diffractive element (for example, a diffractive optical element (DOE) or a holographic optical element (HOE)) or a reflective element (for example, a reflective mirror). The waveguide may guide light emitted by a light source portion to the user's eyes using at least one diffractive element or reflective element. The user may recognize the actual space (or actual environment) behind the display through the display module 240.

According to an embodiment, the audio module 250 may include various audio circuitry and convert sounds to electric signals or vice versa, based on the control of the processor 220. For example, the audio module 250 may include a speaker and/or a microphone.

According to an embodiment, the sensor module 260 may include at least one sensor and sense movements of the AR device 201. The sensor module 260 may sense physical quantities related to movements of the AR device 201, for example, the velocity, acceleration, angular velocity, angular acceleration, or geographical location of the AR device 201.

The sensor module 260 may include various sensors. For example, the sensor module 260 may include a proximity sensor 261, an illuminance sensor 262, and/or a gyro sensor 263, but is not limited thereto. The proximity sensor 261 may sense objects approaching the AR device 201. The illuminance sensor 262 may measure the degree of brightness around the AR device 201. According to an embodiment, the processor 120 may identify the degree of brightness around the AR device 201 using the illuminance sensor 262 and may change brightness-related configuration information of the display module 240, based on the degree of brightness. The gyro sensor 263 may sense the posture and location of the AR device 201. The gyro sensor 263 may sense movements of the AR device 201 or the user wearing the AR device 201.

According to an embodiment, the camera module 270 may include at least one camera and capture still and moving images. According to an embodiment, the camera module 270 may include one or more lenses, image sensors, image signal processors, or flashes.

As an example, the camera module 270 may include at least one of a gesture camera 271, an eye tracking camera 273, a distance measurement camera (depth camera) 275, and/or an RGB camera 277. According to an embodiment, the gesture camera 271 may sense the user's movements. For example, at least one gesture camera 211 may be disposed on the AR device 211 so as to sense the user's hand movements within a preconfigured distance. The gesture camera 271 may include a simultaneous localization and mapping (SLAM) camera for recognizing information (for example, location and/or direction) related to the peripheral space of the AR device 201. The eye tracking camera 273 may track movements of the user's left and right eyes. According to an embodiment, the processor 220 may identify the left eye's gazing direction and the right eye's gazing direction using the eye tracking camera 273. The distance measurement camera 275 may measure the distance from an object positioned in front of the AR device 201. The distance measurement camera 275 may include a time-of-flight (TOF) camera and/or a depth camera. The distance measurement camera 275 may capture images toward the front of the AR device 201, and the eye tracking camera 273 may capture images in the opposite direction to the imaging direction of the distance measurement camera 275. The red green blue (RGB) camera 277 may sense information related to the object's color and information regarding the distance from the object.

According to an embodiment, the gesture camera 271, the eye tracking camera 273, the distance measurement camera 275, and/or the RGB camera 277 included in the camera module 270 may be included in the AR device 201, respectively, or some thereof may be implemented as an integrated camera. For example, the distance measurement camera 275 and the RGB camera 237 may be implemented as a single integrated camera.

According to an embodiment, the processor 220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 220 may, for example, execute a program (for example, the program 140 in FIG. 1) stored in the memory 230, thereby controlling at least one other component (for example, the communication module 210, the display module 240, the audio module 250, the sensor module 260, or the camera module 270) related to the function of the AR device 201, and performing data processing or computation necessary for jobs related to the AR service (for example, AR jobs). For example, the processor 220 may include a computation processing unit.

According to an embodiment, the processor 220 may acquire image information by capturing images related to the actual space corresponding to the FoV of the user wearing the AR device 201 through the camera module 270. The processor 220 may recognize information corresponding to an area deemed to corresponding to the user's FoV among images related to the actual space acquired through the camera module 270 of the AR device 201. The processor 220 may generate a virtual object, based on virtual information based on image information. The processor 220 may display a virtual object related to the AR service together with image information through the display module 240.

According to an embodiment, the processor 220 may measure physical quantities related to movements of the AR device 201 (for example, the geographical location, velocity, acceleration, angular velocity, and angular acceleration of the AR device) through the sensor module 260, and may acquire movement information of the AR device 201 using the measured physical quantities or a combination thereof.

According to an embodiment, the processor 220 may analyze image information and movement information of the AR device 201 in real time such that AR jobs, for example, a head tracking job, a hand tracking job, and an eye tracking job are controlled to be processed.

According to an embodiment, the processor 220 may change the configuration of the display module 160 at least partially, based on information acquired using the at least one camera 311, 313, 315, and 317 included in the camera module 270, thereby managing power consumption.

According to an embodiment, the processor 220 may adjust the performance of a device configuration (for example, the display module 240, the camera module 270, or a battery (not illustrated), based on configuration information (or performance preset) related to the AR service. For example, the AR device 201 may receive configuration information (or performance preset) from another electronic device (for example, the electronic device 101 in FIG. 1). The AR device 201 may at least partially change the configuration of the display module 240 (or the camera module 270 or the battery (not illustrated)), based on the configuration information (for example, turn the display off or change the resolution), thereby managing power consumption.

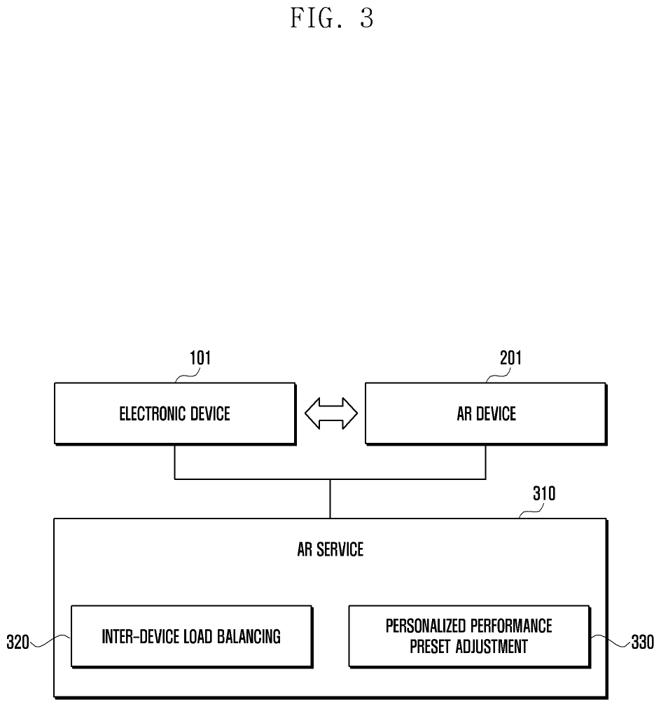

FIG. 3 is a diagram illustrating an example scheme for optimizing the performance of an AR service by an electronic device according to various embodiments.

Referring to FIG. 3, according to various embodiments, the electronic device 101 may provide an AR service 310 by interworking with an AR device 201.

According to an embodiment, the electronic device 101 may have an AR application (hereinafter, referred to as an AR app) installed therein. The AR app may be a software program for providing the AR service 310, but is not limited thereto. The AR app may be replaced with a program that provides a VR or MR service, in addition to the AR. For example, the AR app may be an AR game or an AR tour guide app, but is not limited to the above-described types.

According to an embodiment, the electronic device 101 may be connected to the AR device 201. The electronic device 101 may receive information related to the AR service 310 (for example, information regarding the result of audio, video, or real-time AR jobs), and may generate a virtual object to be output by the AR device 201, based on the received information. The electronic device 101 may transmit information (for example, rendered image information) related to the virtual object to the AR device 201.

The AR device 201 may acquire sensor information and image information by capturing images of the actual environment, and may transmit the same to the electronic device 101 in real time, or may transmit AR job result information acquired based on the image information to the electronic device 101. For example, the AR device 201 may perform various AR jobs for providing the AR service 301 (for example, a head tracking job, a hand tracking job, an eye tracking job, and a scene analysis (for example, scene understanding or rending) job).

The AR device 201 may receive information related to a virtual object from the electronic device 101 and may output the same (the virtual object) together with camera images. For example, information (for example, rendered image information or virtual object information) transferred from the electronic device 101 may be output together with camera images.

The electronic device 101 may provide inter-device load balancing (or inter-device load distribution) 320 in order to optimize the performance of the AR service 310, and may make adjustment (or tuning) 330 to a personalized (or customized) performance preset, depending on the situation.

As an example, when installing or executing an AR app, the electronic device 101 may acquire a basic performance preset (or initial performance preset) including configuration parameters of AR jobs related to the AR service 310 and an inter-device load balancing policy. The basic performance preset may be included in the downloaded AR app or received from a server device (not illustrated) supporting the AR app service.

The electronic device 101 may configure (or set) configurations (for example, the processor) of the electronic device, configurations (for example, the display module, the camera module, and the battery) of the AR device, and AR jobs, based on the configuration parameters and the inter-device load balancing policy included in the basic performance preset.

According to an embodiment, the electronic device 101 may separately configure jobs to be performed by the AR device 201 and jobs to be performed by the electronic device 101, thereby performing inter-device load balancing 320.

According to an embodiment, the electronic device 101 may adaptively process some of AR jobs to be processed by the AR device 201, based on the policy condition of inter-device load balancing 320. The electronic device 101 may adjust the balance between the load of the electronic device 101 and the load of the AR device 201 according to the AR use environment, thereby providing performance optimization.

According to an embodiment, the electronic device 101 may provide a function of making adjustment (or tuning) 330 to a personalized performance preset, together with the inter-device load balancing 320.

The electronic device 101 may collect performance data and AR use environment data while providing an AR service through a connected AR device 301. The electronic device 101 may analyze the collected data and reflect the result of analysis so as to adjust (or tune) 330 a predefined basic performance preset to a personalized (or customized) performance preset appropriate for the current user and environment, thereby providing performance optimization.

Although not illustrated, according to various embodiments, the electronic device 101 may support a function of providing an AR service by interworking with a server device, or performing inter-device load balancing 320 and making adjustment 330 to a personalized performance preset.

Hereinafter, functions of the electronic device 101 for performing inter-device load balancing and making adjustment to a personalized performance preset will be described in detail, and the above-described functions may be performed independently, individually, or in parallel, and may be implemented to interact with each other.

An electronic device according to various example embodiments may include: a communication module comprising communication circuitry (for example, the communication module 190 in FIG. 1) and at least one processor, comprising processing circuitry (for example, the processor 120 in FIG. 1). At least one processor, individually and/or collectively, may be configured to: connect to an augmented reality (AR) device (for example, the AR device 201 in FIG. 3) through the communication module to receive a basic performance set including an inter-device load balancing policy and a configuration parameter related to AR jobs based on providing an AR service, perform inter-device load balancing such that the AR jobs are processed in a distributed manner in the AR device and the electronic device according to processing entities of respective AR jobs, based on the basic performance set, based on an inter-device load balancing changing condition occurring to one of AR jobs currently processed in the AR device, reconfigure a first AR job to which the changing condition occurred, among the AR jobs currently processed in the AR device, so as to be switched and processed in the electronic device, and receive data related to the first AR job from the AR device and process the data.

According to various example embodiments, the AR jobs may include at least one of a head tracking job, a hand tracking job, an eye tracking job, and a scene analysis (for example, scene understanding) or rendering job.

According to various example embodiments, the electronic device may further include a sensor module including at least one sensor (for example, the sensor module 176 in FIG. 1). At least one processor, individually and/or collectively, may be configured to: collect first device performance data and AR use environment data through the sensor module, while performing the AR service, receive second device performance data from the AR device, and monitor whether the load balancing changing condition is changed with regard to at least one of the AR jobs, based on the first device performance data, the second device performance data, and the AR use environment data.

According to various example embodiments, the first device performance data may include at least one of a GPU clock and CPU load of the electronic device, the GPU clock and GPU load of the electronic device, the network type, the type of a tethering network between electronic device and the AR device, tethering network signal intensity, rendering frame per second (FPS), the electronic device's surface temperature, the electronic device's limit temperature, and electronic device resolution. The second device performance data may include at least one of the GPU clock and CPU load of the AR device 201, the GPU clock and GPU load of the AR device, the display frequency of the AR device, the operating temperature of the AR device, the refresh rate of the AR device, the screen brightness of the AR device, the limit temperature of the AR device, network traffic, tracking frequency, tracking coordinates, tracking latency or tracking accuracy, tracking input image quality, scene analysis result, and scene analysis accuracy. The AR use environment data may include at least one of position information of the electronic device and position information of the AR device (for example, GPS-based position information, GEO IP-based position information), error process information during an AR service, AR app use time, and peripheral environment information.

According to various example embodiments, at least one processor, individually and/or collectively, may be configured to, based on a change return condition occurring to the first AR job currently processed in the electronic device, reconfigure the first AR job so as to be processed in the AR device again.

According to various example embodiments, at least one processor, individually and/or collectively, may be configured to: estimate AR context corresponding to a current situation, based on a combination of the electronic device, the AR device, and an AR app, perform performance evaluation corresponding to the estimated AR context, based on the first device performance data, the second device performance data, and the AR use environment data, generate a personalized performance set by adjusting at least a part of configuration parameters of the basic performance preset, based on the performance evaluation result, and apply the generated personalized performance preset to the AR service.

According to various example embodiments, the communication module of the electronic device may be connected to a server. At least one processor, individually and/or collectively, may be configured to perform control such that attribute information of the electronic device, attribute information of the AR device, and an AR app attribute information are transmitted to the server device through the communication module, and a basic performance preset appropriate for a combination of at least one of the electronic device, the AR device, and the AR app is received from the server device.

According to various example embodiments, at least one processor, individually and/or collectively, may be configured to control the electronic device to transmit the first device performance data, the second device performance data, and the AR use environment data to the server, and receive a personalized performance set appropriate for a combination of the first device performance data, the second device performance data, and the AR use environment data from the server device.

According to various example embodiments, at least one processor, individually and/or collectively, may be configured to communicate with the server device through the communication module to classify the first device performance data, the second device performance data, and the AR use environment data into data for performance evaluation, calculate a performance evaluation score with regard to each AR performance evaluation factor, select at least one first parameter requiring micro-adjustment among configuration parameters included in the basic performance set, based on the performance evaluation score, and generate the personalized performance parameter by micro-adjusting the selected at least one first parameter.

An electronic device according to various example embodiments may include a communication module, comprising communication circuitry and at least one processor, comprising processing circuitry. At least one processor, individually and/or collectively, may be configured to connect to an augmented reality (AR) device through the communication module to receive a basic performance set including an inter-device load balancing policy and a configuration parameter related to AR jobs when providing an AR service, perform inter-device load balancing such that the AR jobs are processed in a distributed manner in the AR device and the electronic device according to processing entities of respective AR jobs, based on the basic performance set, based on an inter-device load balancing changing condition occurring to one of AR jobs currently processed in the AR device, reconfigure a first AR job to which the changing condition occurred, among the AR jobs currently processed in the AR device, so as to be switched and processed in the electronic device, and receive data related to the first AR job from the AR device and process the data.

According to various example embodiments, the AR jobs may include at least one of a head tracking job, a hand tracking job, an eye tracking job, and a scene analysis (for example, scene understanding) or rendering job.

According to various example embodiments, the electronic device may further include a sensor module including at least one sensor. At least one processor, individually and/or collectively, may be configured to collect first device performance data and AR use environment data through the sensor module, while performing the AR service, receive second device performance data from the AR device, and monitor whether the load balancing changing condition is changed with regard to at least one of the AR jobs, based on the first device performance data, the second device performance data, and the AR use environment data.

According to various example embodiments, the first device performance data may include at least one of GPU clock and CPU load of the electronic device, the GPU clock and GPU load of the electronic device, the network type, the type of a tethering network between electronic device and the AR device, tethering network signal intensity, rendering frame per second (FPS), the surface temperature of the electronic device, the limit temperature of the electronic device, and electronic device resolution. The second device performance data may include at least one of the GPU clock and CPU load of the AR device, the GPU clock and GPU load of the AR device, the display frequency of the AR device, the operating temperature of the AR device, the refresh rate of the AR device, the screen brightness of the AR device, the limit temperature of the AR device, network traffic, tracking frequency, tracking coordinates, tracking latency or tracking accuracy, tracking input image quality, scene analysis result, and scene analysis accuracy. The AR use environment data may include at least one of position information of the electronic device and position information of the AR device (for example, GPS-based position information, GEO IP-based position information), error process information during an AR service, AR app use time, and peripheral environment information.

According to various example embodiments, at least one processor, individually and/or collectively, may, based on a change return condition occurring to the first AR job currently processed in the electronic device, reconfigure the first AR job so as to be processed in the AR device again.

According to various example embodiments, at least one processor, individually and/or collectively, of the electronic device may be configured to estimate AR context corresponding to a current situation, based on a combination of the electronic device, the AR device, and an AR app, perform performance evaluation corresponding to the estimated AR context, based on the first device performance data, the second device performance data, and the AR use environment data, generate a personalized performance set by adjusting at least a part of configuration parameters of the basic performance set, based on the performance evaluation result, and apply the generated personalized performance set to the AR service.

According to various example embodiments, the communication module may be connected to a server. At least one processor, individually and/or collectively, may be configured to perform control such that attribute information of the electronic device, attribute information of the AR device, and an AR app attribute information are transmitted to the server device through the communication module, and a basic performance preset appropriate for a combination of at least one of the electronic device, the AR device, and the AR app is received from the server device.

According to various example embodiments, at least one processor, individually and/or collectively, may be configured to control the electronic device to transmit the first device performance data, the second device performance data, and the AR use environment data to the server device, and receive a personalized performance preset appropriate for a combination of the first device performance data, the second device performance data, and the AR use environment data from the server device.

According to various example embodiments, at least one processor, individually and/or collectively, may be configured to communicate with the server device through the communication module so as to classify the first device performance data, the second device performance data, and the AR use environment data into data for performance evaluation, calculate a performance evaluation score with regard to each AR performance evaluation factor, select at least one first parameter requiring micro-adjustment among configuration parameters included in the basic performance preset, based on the performance evaluation score, and generate the personalized performance parameter by micro-adjusting the selected at least one first parameter.

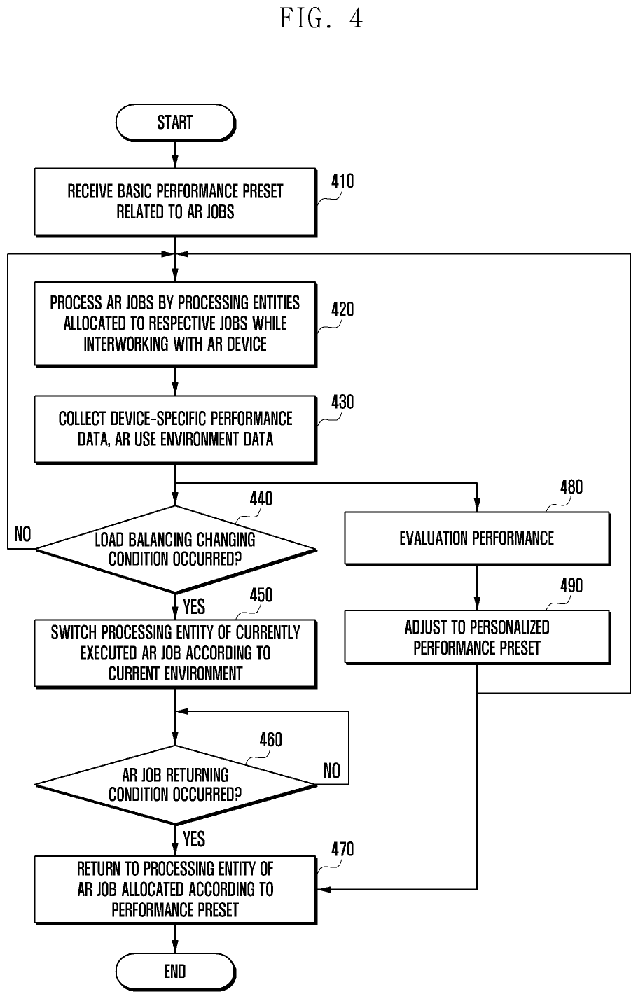

FIG. 4 is a flowchart illustrating an example method for optimizing the performance of an AR service by an electronic device according to various embodiments.

Referring to FIG. 4, according to various embodiments, the processor (for example, the processor 120 in FIG. 1) of the electronic device (for example, the electronic device 101 in FIG. 1) may acquire a basic performance preset (or an initial performance preset) (for example, a predefined performance preset) of AR jobs related to an AR service, when providing the AR service after connecting to an AR device (for example, the AR device 201 in FIG. 2) in operation 410.

The basic performance preset (which may also be referred to herein as a “set”) may include configuration parameters of AR jobs and an inter-device load balancing policy. For example, the basic performance preset may include at least one from among a CPU driving range (for example, maximum and minimum values) regarding each device, a GPU driving range (for example, maximum and minimum values) regarding each device, a temperature limit range regarding each device, information regarding entities that process AR jobs, processing core types, image quality information, job ranking information, job frequency information, and job processing entity switching condition information, but is not limited to the above-described information.

As an example, the basic performance preset may be received from a server device supporting an AR service, but may also be included in AR app download information (or AR app package).

According to an embodiment, the processor 120 of the electronic device 101 may execute an AR app in response to the user's AR app execution request (for example, an input event for executing an AR app), and may control connection to an AR device (for example, the AR device 201 in FIG. 2). For example, the processor 120 may search for an AR device through a communication module, and may form a communication session (or wireless communication channel) with the discovered AR device 201. The processor 120 may transmit/receive data with the AR device 201 through the communication session.

According to various embodiments, if an AR device 201 is connected, the electronic device 101 may receive device attribute information (or metadata) of the AR device 201.

The device attribute information may include information such as the model name (for example, AR device model name), the type, identification information, and the manufacturer, but is not limited thereto. For example, the electronic device 101 may transfer device attribute information of the AR device connected to the electronic device, device attribute information of the electronic device (for example, the electronic device's model name, type, and identification information), and information regarding attributes of AR apps installed in the electronic device (for example, AR app names, services types, and app types (or categories)) to a server device (not illustrated) supporting an AR service, and may receive a basic performance preset appropriate for the electronic device, AR device, and AR app characteristics from the server device.

In operation 420, the processor 120 may interwork with the AR device 201 such that processing entities (for example, the electronic device or the AR device) allocated to respective AR jobs process AR jobs in a distributed manner (in other words, through inter-device load balancing), thereby performing an AR service.

According to an embodiment, the electronic device 101 and the AR device 201 may control AR jobs to be processed in a distributed manner, based on an inter-device load balancing policy included in a basic performance preset. For example, jobs (for example, host job 1, host job 2 . . . host job N) having a job entity defined as an electronic device (for example, phone) may be allocated to the electronic device 101, and jobs (for example, AR job 1, AR job 2 . . . . AR job N) having a job entity defined as an AR device (for example, hmd) may be allocated to the AR device 201.

An example of a basic performance preset is illustrated in [Table 1] below for convenience of description, but this is only an example and is not limitative.

TABLE 1

```
{
“smartphone”:”
“device_name: “phone01”,
“device_max_temperature_limit” 45,
“max_cpu_clock”: 2500
“mib_cpu_clock”: 2000
“max_cpu_clock”: 2500
“max_cpu_clock”: 1000
“reserved_ap+core” : [
1,
2
]
}
“hmd”: {
“device_name: “hmd01”,
“device_max_temperature_limit” 42,
“max_cpu_clock”: 1500
“mib_cpu_clock”: 1000
“max_cpu_clock”: 1500
“max_cpu_clock”: 1000
}
“ar_app metatata”: {
“package_ name”: “good.ar.app.apk”
“tracking_latency_importance” :5
}
“tracking_config”: {
“head” : {
“processing_unit”: “hmd01”,
“processing_unit_switch_enable”: false,
“tracking_freg”: 60
    }
“head” : {
“processing_unit”: “hmd01”,
“tracking_freg”: 30
“input_image_quality:” “480p”
“processing_unit_switch_enable”: ture,
“processing_unit_switch_condition: {
  “overheat_rate_exceed”: 0.9,
  “ remain_battery_less_than: 0.2
}
“eye” : {
“processing_unit”: “hmd01”,
“processing_unit_switch_enable”: false,
“tracking_freg”: 0
“input_image_quality:” “240p”
“scene” : {
“processing_unit”: “phone01”,
“processing_unit_switch_enable”: false,
“tracking_freg”: 3
“input_image_quality:” “1080p”
```

It may be identified from [Table 1] above that the processing entity of the head, hand, and eye tracking jobs, among tracking jobs related to the AR service, is an AR device (for example, hmd01), and the processing entity of the scene analysis (or scene tracking) (for example, scene understanding) job is an electronic device (for example, phone 01).

The processor 120 may control the electronic device 101 and the AR device 201 such that processing entities allocated to the basic performance preset process AR jobs.

In operation 430, the processor 120 may collect device performance data and AR use environment data while performing the AR service (or while a communication session is connected to the AR device after an AR app is executed).

According to an embodiment, the device performance data may include first device performance data and second device performance data. The first device performance data, which is acquired by the electronic device, may include, for example, at least one from among the electronic device's GPU clock and CPU load, the electronic device's GPU clock and GPU load, the network type, the type of a tethering network with the AR device, tethering network signal intensity, rendering frame per second (FPS), surface temperature, limit temperature, and electronic device resolution, but is not limited thereto.

The second device performance data, which is acquired by the AR device, may include, for example, at least one from among the AR device's GPU clock and CPU load, the AR device's GPU clock and GPU load, display frequency, AR device temperature, refresh rate, screen brightness, limit temperature, network traffic, tracking frequency, tracking coordinates, tracking latency or tracking accuracy, tracking input image quality, scene analysis result, and scene analysis accuracy, but is not limited thereto.

According to various embodiments, the first device performance data and the second device performance data may vary as the entities that process AR jobs are changed.

The AR use environment data may be information such as the electronic device's position information and the AR device's position information (for example, GPS-based position information, GEO IP-based position information), electronic device average driving temperature, information regarding error processes during the AR service, AR app use time, and peripheral environment information, but is not limited thereto.

In operation 440, the processor 120 may identify, based on collected data, whether a condition to change inter-device load balancing occurs.

According to an embodiment, the processor 120 may monitor the electronic device 101, the AR device 201, and AR app situations, based on collected data, thereby assessing the load situation of resources of the electronic device 101 or the AR device 201. The processor 120 may identify whether a load balancing changing condition occurs or not, based on job processing entity switching condition information included in the basic performance preset.

As an example, it may be identified from the head tracking of the basic performance preset in [Table 1] that the job processing entity switching condition is that a configured temperature is exceeded (for example, “overheat_rate_exceed”: 0.9), or a battery threshold is reached or less (for example, remain_battery_less_than: 0.2). The processor 120 may monitor collected data and may determine that, if a situation corresponding to a switching condition related to the head tracking job occurs, a load balancing changing condition has occurred.

In operation 450, if a load balancing changing condition occurs, the processor 120 may switch the entity that processes at least some AR jobs which are being executed according to the current environment (in other words, perform load rebalancing). The processor 120 may proceed to operation 420 if no load balancing changing condition occurs.

According to an embodiment, the processor 120 may control AR jobs currently executed by the electronic device 101 or the AR device 201 to be switched to another device according to the current load situation.

For example, if a processing entity changing condition occurred to a job currently executed by the AR device 201 (for example, AR job 1), the processor 120 may allocate the core of the electronic device 101 as the core for processing AR job 1 from the processing unit of the AR device 201, and may transmit an entity switching command related to AR job 1 to the AR device 201. The AR device 201 may transmit data (for example, sensing information) related to AR job 1 to the electronic device 101.

The processor 120 may control data related to AR job 1 received from the AR device 201 to be processed through the allocated core.

As an example, in a situation in which the AR device 201 exceeded a configured temperature (for example, “overheat_rate_exceed”: 0.9) in [Table 1], the processor 120 may switch the job processing entity such that the electronic device 101 processes the head tracking job currently executed by the AR device 101 in order to alleviate heating.

According to an embodiment, if a load balancing changing condition occurs, the processor 120 may control AR jobs currently executed by the electronic device 101 or the AR device 201 such that the load ratio is adjusted according to the current load situation, and the AR jobs are processed in a distributed manner according to the load ratio (or load rebalancing). For example, if a load balancing changing condition occurred to the job currently executed by the AR device (for example, AR job 2), the processor 102 may identify the device-specific load situation, may control a piece of data related to AR job 2 to be processed by the AR device 201, and may control another piece of data related to AR job 2 to be processed by the electronic device 101.

In operation 460, the processor 120 may identify whether an AR job return condition occurs while executing an AR service (or while an AR app is executed). If a return condition occurs, the processor 120 may proceed to operation 470. If no return condition occurs, the processor 120 may proceed back to operation 460 and continuously monitor whether a return condition occurs.

In operation 470, the processor 120 may return to the AR job processing entity allocated according to the basic performance preset in response to the occurrence of an AR job return condition.

In operation 480, the processor 120 may perform performance evaluation, based on performance data and AR use environment data, while executing an AR service (or while an AR app is executed).

According to an embodiment, operation 480 may be performed individually or independently of operations 420 to 470.

According to an embodiment, the processor 120 may preprocess pieces of collected data, thereby selecting pieces of data appropriate for performance measurement. For example, the processor 120 may classify pieces of collected data (for example, first device performance data, second device performance data, and AR use environment data) into data appropriate for AR app performance evaluation and inappropriate data.

For example, the processor 120 may collect data as time-series data, may label the same as in an idle state and an active state with regard to each time period, and may guide-learn the labeled data, thereby generating a machine learning model. When new performance data is collected based on the generated machine learning model, the processor 120 may identify whether the new performance data is in an idle state or in an active state, and may classify the collected performance data as appropriate data when the same is in an active state. The processor 120 may estimate AR context appropriate for the current situation (or driving environment), based on pieces of data classified as appropriate data. The AR context may be determined based on a combination of the electronic device, the AR device, and the AR app.

For example, AR context based on a combination of a smartphone, AR glasses, and a weather AR app may be determined such that weather information is provided as AR content in a specific area of the FoV of the AR glasses. In this case, weather AR context requires no tracking function, and the performance preset related to jobs of the weather app may be set in the electronic device and the AR device such that the tracking-related function exhibits the “lowest” performance.

As another example, AR context based on a combination of a smartphone, AR glasses, and a furniture arrangement AR app may be determined such that a virtual furniture object is arranged in an indoor image through AR glasses. In the case of a furniture arrangement AR app, it is important to track three-dimensional coordinate information regarding the room structure/furniture objects in real time. Therefore, the performance preset related to jobs of the furniture arrangement app may be set in the electronic device and the AR device such that the tracking-related function exhibits the “maximum” performance even though the battery power saving performance is lowered.

According to an embodiment, the processor 120 may calculate performance scores with regard to respective performance valuation factors according to the AR context. The performance valuation factors may include, for example, at least one from among rendering FPS, rendered image to display latency, head tracking latency, hand tracking latency, eye tracking latency, scene understanding latency, head tracking accuracy, hand tracking accuracy, eye tracking accuracy, scene understanding accuracy, GPU load, CPU load, power consumption, and temperature, but is not limited thereto.

According to an embodiment, the processor 120 may calculate a performance score by adding a weight configured with regard to each AR context. For example, in the case of AR context, the tracking latency of which is estimated to be important, the processor 120 may configure a high weight for the performance evaluation factor related to the tracking latency.

According to various embodiments, the weight may have a different weight value depending on information regarding the electronic device, the AR device, the AR app, or the AR use environment.

In operation 490, the processor 120 may adjust (or tune) the predefined basic performance preset to a personalized parameter preset, based on the result of performance evaluation.

According to an embodiment, the processor 120 may micro-adjust configuration parameters included in the basic performance preset, based on a performance evaluation score that follows AR context corresponding to the current situation (or driving environment), such that a personalized performance preset is generated (or configured) and applied.

As an example, if the basic performance preset corresponding to AR context of the furniture arrangement app is set such that the tracking performance is “maximum” performance, the processor 120 may expect that performance degradation because the performance evaluation factor related to heating is higher than a reference value (or may calculate the performance score to be lower than a configured value). In this case, the processor 120 may micro-adjust configuration parameters related to the tracking function handled by the AR device, thereby optimizing the tracking function from the “maximum” level to the “normal” level.

If the performance evaluation is low although the tracking function handled by the AR job has been adjusted to the “normal” level, the processor 120 may change the processing entity such that the electronic device performs the tracking function while tolerating an increase in tracking latency.

For example, when providing an AR service, the processor 120 may estimate the weather/season in the area in which the same is used. If the use environment is higher than a normal temperature, the processor 120 may adjust the parameter related to heating alleviation, among configuration parameters included in the predefined basic performance preset such that a personalized performance preset is generated and applied, thereby conducting performance optimization.

According to various embodiments, the predefined basic performance preset may be implemented as multiple performance preset sets, depending on the situation. After a performance preset appropriate for the current situation is designated among the multiple performance preset sets, the electronic device 101 may perform personalized micro-adjustment (or tuning) with regard to the designated performance preset.

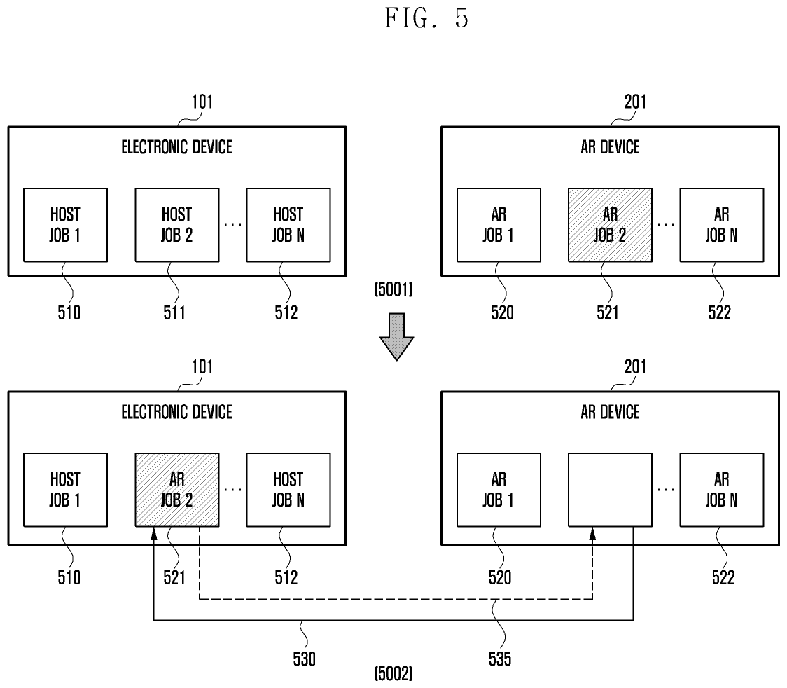

FIG. 5 is a diagram illustrating example device load balancing operations of an electronic device and an AR device according to various embodiments.

Referring to FIG. 5, according to an embodiment, when providing an AR service while interworking with the electronic device (for example, the electronic device 101 in FIG. 1) and the AR device (for example, the AR device 201 in FIG. 2), distributed processing (or load balancing) regarding AR jobs may be performed.

The electronic device 101 may process AR jobs allocated to the electronic device 101 according to configuration parameters included in a basic performance preset, and the AR device 201 may process AR jobs allocated to the AR device.

According to an embodiment, as indicated by [5001], jobs (for example, host job 1 (510), host job 2 (511) . . . host job N (512)) having a job entity defined as an electronic device (for example, phone) may be allocated to the electronic device 101, and jobs (for example, AR job 1 (520), AR job 2 (521) . . . . AR job N (522)) having a job entity defined as an AR device (for example, hmd) may be allocated to the AR device 201.

If a load balancing changing condition occurs based on device performance data and AR use environment data collected during the AR service, the electronic device 101 may switch the AR job entities, thereby conducting performance optimization appropriate for the load situation of the electronic device 101 and the AR device 201.

According to an embodiment, as indicated by [5002], if a load balancing changing condition of AR job 2 (521) occurs while the AR device 201 processes AR job 2 (521), the electronic device 101 may switch AR job 2 (521) so as to be processed by the electronic device 101, as in operation 530.

Assuming that AR job 2 (521) is a hand tracking job, for example, the AR device 201 may transmit data/resources used for hand tracking (for example, sensing information, position information) to the electronic device 101. The electronic device 101 may process AR job 2 (521), based on the resources transferred from the AR device 201, using a core allocated to process AR job 2 (521).

Thereafter, if a job processing returning condition occurs (for example, a condition of situation change such that AR job 2 (521) can be processed by the AR device AR device 201) as a result of monitoring, the electronic device 101 may switch the processing entity such that currently processed AR job 2 (521) is again processed by the AR device 201, as in operation 535.

Hereinafter, an AR service provided using an electronic device, an AR device, and a server device will be described in greater detail.

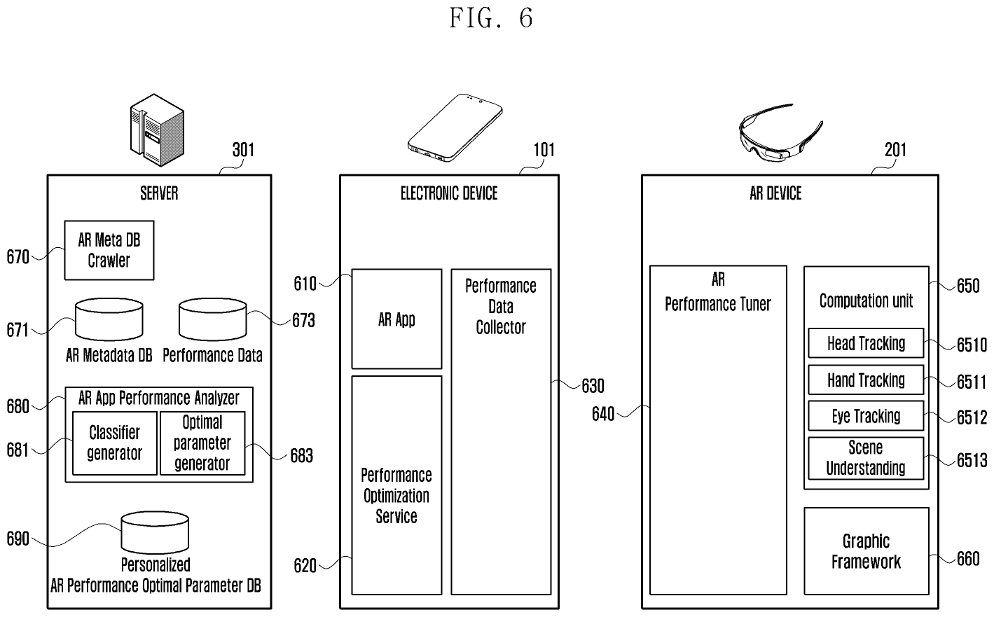

FIG. 6 is a diagram illustrating an example configuration of a system including an electronic device, an AR device, and a server according to various embodiments.

Referring to FIG. 6, according to various embodiments, the electronic device 101 may connect to the AR device 201 and the server device (e.g., server) 301 so as to provide an AR service.

According to an embodiment, the electronic device 101, the AR device 201, and the server device 301 may be connected through a wireless network. For example, the electronic device 101 may be connected to the AR device 201 through a first network, and may be connected to the server device 301 through a second network. According to various embodiments, the AR device 201 may be directly connected to the server device 301. For example, the first network may be based on at least one wireless communication scheme from among WiFi-P2P, Bluetooth, and Bluetooth low energy (BLE), but is not limited to the above-described examples.

According to an embodiment, the electronic device 101 may provide the server device 301 with attribute information of the AR device 201, the electronic device 101, and the AR app 610 installed in the electronic device 101, and may receive a performance preset (or job configuration value, parameter preset data) (for example, basic performance preset) according to a combination of at least one of the AR device 201, the electronic device 101, and the AR app 610 from the server device 301.

According to an embodiment, the electronic device 101 may transmit device performance date (for example, first device performance date, second device performance date) and AR use environment data collected while the AR service is provided to the server device 301, may receive a personalized performance preset appropriate for the AR use environment from the server device 301, and may apply the same to the AR service.

The following description may be directed to functions for providing an AR service with a personalized performance according to the AR use environment in relation to the AR service.

The electronic device 101 may include an AR app 610, a performance optimization service module 620, and a performance data collection module (for example, performance data collector) 630. The AR device 201 may include an AR performance tuner 640, a computation unit 650 (for example, real-time computation processing unit), and a graphic framework 660.

The AR performance tuner 640 may establish a communication session with the electronic device 101 and may apply a performance preset (in other words, job configuration value) (for example, basic performance preset) transferred from the electronic device 101, thereby executing an AR service. As used herein, the performance preset may be an initial performance parameter preset or basic performance preset.

The AR performance tuner 640 may collect performance data related to the AR service while the communication session remains connected. The AR performance tuner may collect performance data (for example, second device performance data) such as frames per second (FPS), surface temperature, GPU load, CPU load, refresh rate, screen brightness, network type, network traffic, tracking latency, or tracking accuracy while the communication session is maintained (or while the AR service is exposed to the AR device).

According to an embodiment, the AR performance tuner 640 may transfer performance data to the electronic device periodically or in real time while the communication session is maintained, and may record collected performance data in the memory of the AR device 201 if the communication session is ended.

The AR performance tuner 640 may receive a personalized performance preset tuned with regard to each of the AR device 201, the electronic device 101, the AR app 610, and the user from the electronic device 101, and may apply (or reconfigure) the personalized performance preset so as to provide an AR service.

The computation unit (for example, real-time computation processing unit) 650 may process AR jobs performed when the AR service is provided, in real time. The AR jobs may include, for example, a head tracking job 6510, a hand tracking job 6511, an eye tracking job 6512, and a scene analysis (for example, scene understanding) 6513 or rending job (not illustrated), but are not limited thereto.

The graphic framework 660 may process display of rendered images, based on images received through the camera of the AR device and virtual information transferred from the electronic device.

According to an embodiment, the performance data collection module 630 of the electronic device 101 and the performance optimization service module 620 thereof may comprise a part of the processor (for example, the processor 120 in FIG. 1) of the electronic device 101. The processor 120 of the electronic device 101 may control the performance data collection module 630 and the performance optimization service module 620.

The performance data collection module 630 may collect device performance data (for example, first device performance data and second device performance data) and AR use environment data while an AR service is executed (or while a communication session is connected to the AR device after an AR app is executed), and may transfer the same to the performance optimization service module 620. For example, the device performance data may include first device performance data collected in relation to the AR service inside the electronic device 101 and second device performance data collected in relation to the AR service inside the AR device 201.

The performance optimization service module 620 may transfer attribute information of the electronic device 101, the AR device 201, and the AR app 610 to the server device 301, and may receive a performance preset (for example, basic performance preset) appropriate for a combination of the electronic device 101, the AR device 201, and the AR app 610 from the server device 301. The basic performance preset may include configuration parameters of AR jobs related to the AR service, and an inter-device load balancing policy. The performance optimization service module 620 may configure configuration parameters based on the basic performance preset acquired in relation to the AR app 610, and may apply the load balancing policy during the AR service.

The performance optimization service module 620 may monitor the AR use environment, may identify whether a load balancing changing condition (for example, a condition to change the processing entity of at least some AR jobs currently executed) occurs according to the AR use environment, and may control the processing entity of at least some AR jobs to be switched or returned to if the changing condition occurs.

The performance optimization service module 620 may transfer device performance data and AR use environment data transferred from the performance data collection module 630 to the server device 301, and may receive a personalized (or customized) performance preset suitable for the current situation from the server device. The performance optimization service module 620 may adjust (or tune/reconfigure) configuration parameters, based on the personalized performance preset, and may apply the same to the AR service.

According to various embodiments, the performance optimization service module 620 may analyze data transferred from the performance data collection module 630 without connection to the server device, thereby performing performance evaluation, and may micro-adjust (or tune) the basic performance parameter preset to a personalized performance preset, based on the result of performance evaluation.

According to an embodiment, the server device 301 may include an AR metadata crawler 670 (for example, AR meta crawler), an AR metadata database (DB) 671, a performance data DB 673, a performance analyzer 680, and an optimal parameter DB 690.

The AR metadata crawler 670 may collect device attribute information and AR app attribute information (or metadata) and may store the same in the AR metadata database (DB) 671. For example, the device attribute information may include device types and model names, and the AR app attribute information may include AR app types, names, and fields (or categories), but are not limited to the above-described information.

The performance data DB 673 may store device performance data transferred from the electronic device 101.

The performance analyzer 680 may include a classifier generator 681 and an optimal parameter generator 683. The performance analyzer 680 may generate an optimal performance preset (or personalized performance preset) according to a combination of at least one of the electronic device, the AR device, the AR app, and the user environment, based on data collected from the electronic device 101, and may store the same in the optimal parameter DB 690. For example, the classifier generator 681 may implement modeling (for example, machine learning model) for classifying data collected from the electronic device into pieces of data appropriate for performance optimization. The optimal parameter generator 683 may select a performance preset appropriate for the AR use situation of the electronic device 101 from the optimal parameter DB 690 in response to a request signal of the electronic device 101, and may transfer the same.

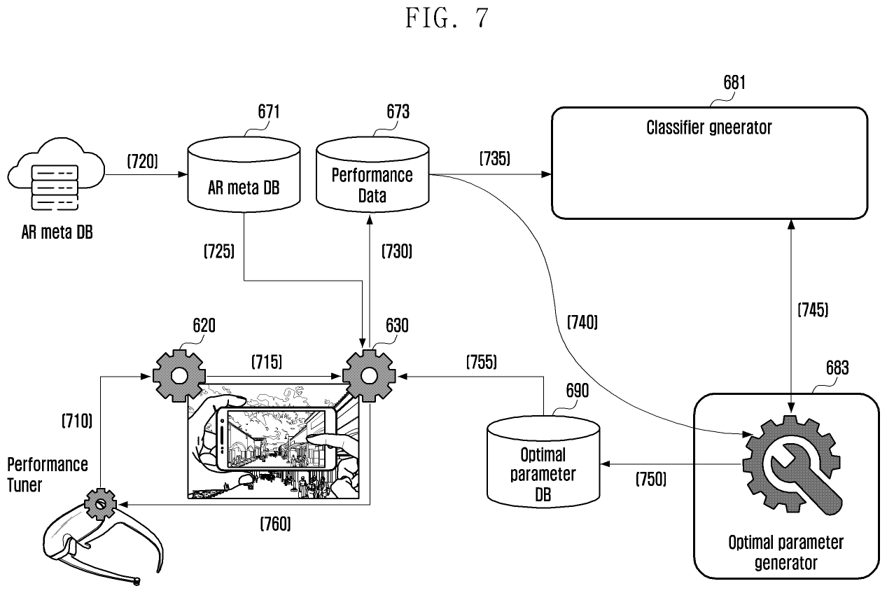

FIG. 7 is a diagram illustrating an example configuration of a system including an electronic device, an AR device, and a server according to various embodiments.

Operations of the system according to an embodiment will be described with reference to FIG. 7. In operation 710, the AR performance tuner 640 of the AR device 201 may periodically connect device performance data (for example, second device performance data) and may provide the device performance data to the performance data collection module 630 of the electronic device 101.

The performance data collection module 630 of the electronic device 101 may store the device performance data (for example, second device performance data) transferred from the AR device 201 and may collect device performance data (for example, first device performance data) of the electronic device 101.

In operation 715, the performance data collection module 630 of the electronic device 101 may transfer the device performance data to the performance optimization service module 620.

Additionally, the performance data collection module 630 may collect AR use environment data during the AR service and may transfer the same to the performance optimization service module 620.

Independently of operations 710 and 715, in operation 720, the server device 301 may collect attribute information of the AR app installed in the electronic device 101 and store the same in the AR metadata DB 971. In operation 725, the server device 301 may provide the performance optimization service module 620 of the electronic device 101 with data appropriate for characteristics of the electronic device 101, the AR device 201, and the AR app, for the sake of performance optimization, among pieces of data stored in the AR metadata DB 971.

In operation 730, the performance optimization service module 620 of the electronic device 101 may transfer device performance data (for example, first device performance data, second device performance data) acquired during the AR service and AR use environment data to the server device 301. The server device 301 may store the data transferred from the electronic device 101 in the performance data DB.

In operation 735, the server device 301 may transfer the data transferred from the electronic device 101 (for example, performance data and AR use environment data) to the classifier generator 681 of the performance analyzer 680.

The classifier generator 681 may learn and model data transferred from the electronic device 101, thereby generating a classifier appropriate for classification of data appropriate for AR performance analysis and evaluation.

In operation 745, the server device 301 may provide the generated classifier to the optimal parameter generator 683.

If the optimal parameter generator 683 already has a classifier appropriate for performance analysis, the server device 301 may provide performance data to the optimal performance parameter generating module such that the performance parameter generating module can directly analyze performance data and generate optimal performance parameters, in operation 740.

The server device 301 may use the classifier and the optimal parameter generator 683 so as to analyze the AR use pattern, classify pieces of data appropriate for optimal performance measurement, and determine optimal performance parameters with regard to the electronic device 101, the AR device 201, the AR app, and the user, respectively.

In operation 750, the server device 301 may store optimal performance parameters related to the electronic device 101, the AR device 201, the AR app, and the user, respectively, in the optimal parameter DB.

In operation 755, the server device 301 may transfer an optimal performance preset or personalized (or customized) performance preset that follows a combination of at least one from among the electronic device 101, the AR device 201, the AR app information, and the AR use environment information, based on data stored in the optimal parameter DB, in response to a request of the electronic device 101.

In operation 760, the electronic device 101 may transfer the performance preset to the performance tuner of the AR device 201, and may apply a policy applicable to the AR device 201 and the electronic device 101, based on the performance preset, thereby providing an AR service.

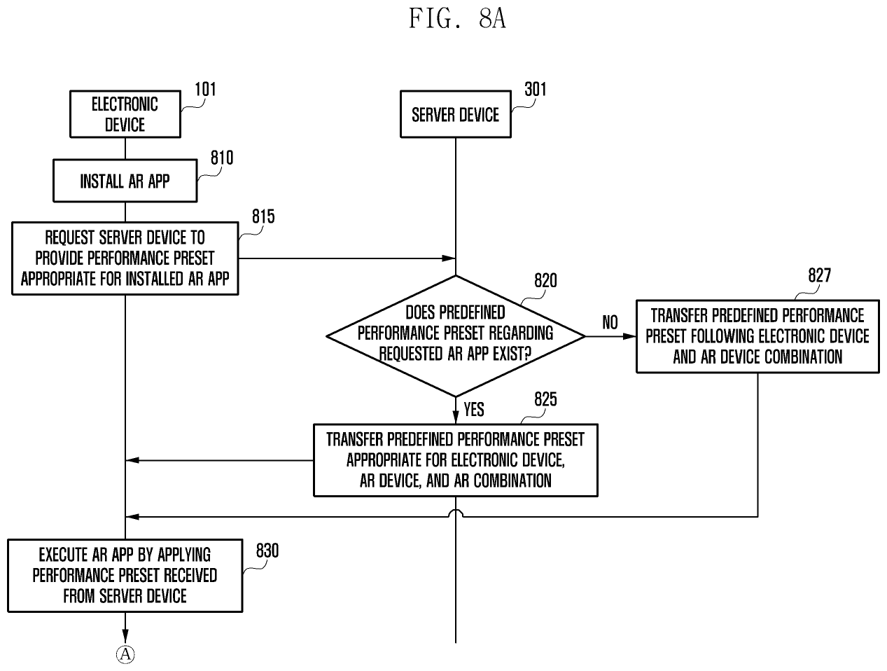

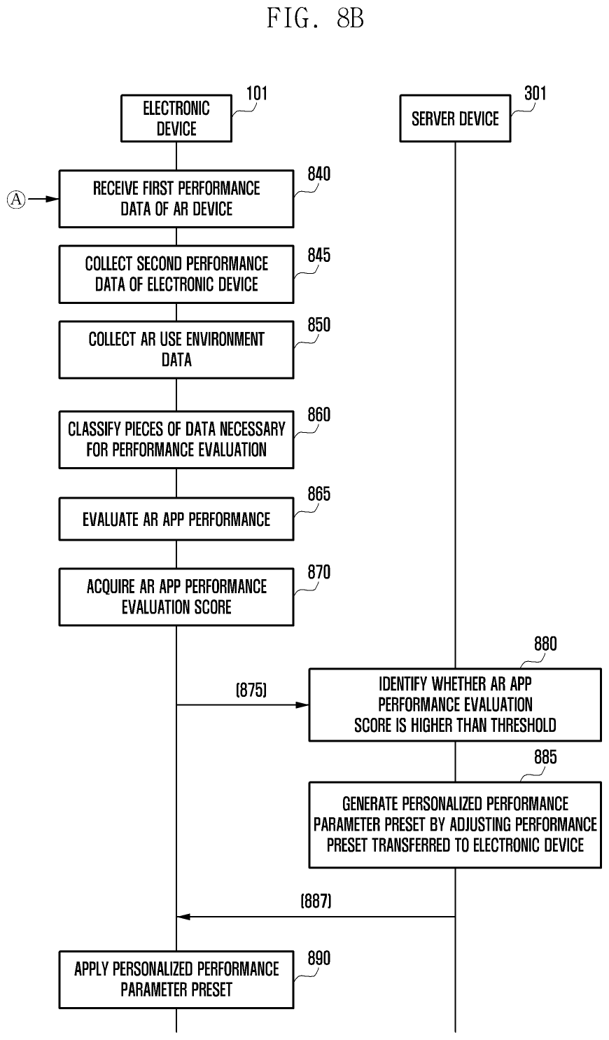

FIG. 8A and FIG. 8B are flowcharts illustrating an example method for optimizing an AR service by an electronic device and a server device according to various embodiments.

Referring to FIG. 8A and FIG. 8B, according to an embodiment, the electronic device 101 may have an AR application (hereinafter, referred to as an AR app) installed therein in operation 810. During AR app installation, the electronic device 101 may connect to an AR device interworking with the electronic device so as to acquire attribute information of the AR device.

In operation 815, the processor (for example, the processor 120 in FIG. 1) of the electronic device 101 may request the server device 301 to provide a performance preset (for example, basic performance preset) appropriate for the installed AR app.

For example, the processor 120 of the electronic device 101 may transfer attribute information of the AR app, attribute information of the electronic device 101, and attribute information of the AR device 201 to the server device 301.

In operation 820, the server device 301 may identify whether there is a performance preset regarding the AR app requested by the electronic device 101. For example, the server device 301 may identify the type of the AR device 201, the type of the electronic device 101, and characteristics of the AR app, and may identify whether there are performance presets predefined according to a combination thereof.

In operation 825, if there is a performance preset appropriate for a combination of the electronic device 101, the AR device 201, and the AR app, the server device 301 may provide the electronic device 101 with the performance preset appropriate for a combination of the electronic device 101, the AR device 201, and the AR app.

In operation 827, if there is no performance preset appropriate for a combination of the electronic device 101, the AR device 201, and the AR app, the server device 301 may provide the electronic device 101 with a performance preset appropriate for a combination of the electronic device 101 and the AR device 201.

In operation 830, the processor 120 of the electronic device 101 may execute an AR app by applying the performance preset (for example, basic performance preset) transferred from the server device 301, and may provide an AR service.

In this regard, the processor 120 of the electronic device 101 may configure the electronic device and the AR device, based on configuration parameters of the performance preset, and may apply inter-device load balancing, based on a load balancing policy.

In operation 840, while the AR app is executed, the processor 120 of the electronic device 101 may receive first device performance data that can be acquired in the AR device from the AR device, and in operation 845, may collect first device performance data that can be acquired in the electronic device 101. In operation 850, the processor 120 of the electronic device 101 may collect AR use environment data while the AR app is executed.

Operations 840, 845, and 850 have no limitations in order, and may be performed in parallel or independently.

In operation 860, the processor 120 of the electronic device 101 may classify pieces of data necessary for performance evaluation, based on collected data.

According to an embodiment, the processor 120 of the electronic device 101 may preprocess pieces of data so as to select pieces of data necessary for performance measurement. For example, the processor 120 may classify pieces of collected data into appropriate data and inappropriate data. For example, the processor 120 may collect data as time-series data, may label the same as in an idle state and an active state with regard to each time period, and may guide-learn the labeled data, thereby generating a machine learning model. When new performance data is collected based on the generated machine learning model, the processor 120 may identify whether the new performance data is in an idle state or in an active state, and may classify the collected performance data as appropriate data when the same is in an active state.

According to various embodiments, the electronic device 101 may receive information related to a data classifier from the server device 301 or may select collected pieces of data while interworking with the server device 301.

In operation 865, the processor 120 of the electronic device 101 may perform AR app performance evaluation based on selected data (for example, appropriate data). In operation 870, the processor 120 of the electronic device 101 may acquire an AR app performance evaluation score.

As an example, the processor 120 may estimate AR context appropriate for the current situation, based on pieces of data classified as appropriate data. The AR context may be determined based on a combination of the electronic device, the AR device, and the AR app.

The processor 120 may calculate performance scores with regard to respective performance valuation factors according to the AR context. A weight may be configured for a specific performance evaluation factor with regard to each AR context. The weight may have a different weight value depending on information regarding the electronic device 101, the AR device 201, the AR app, or the AR use environment. The processor 120 may calculate a performance score by inputting a weight configured according to AR context. For example, weights configured according to AR context may be categorized into tracking latency related weights, operating time related weights, and graphic related weights, and respective weights may have independent values with regard to each AR context. For example, in the case of AR context, the tracking latency of which is important, the processor 120 may configure the weight value related to tracking latency to be higher than weight values of other categories, thereby calculating a performance evaluation score.

In operation 875, the processor 120 of the electronic device 101 may transfer the performance evaluation score to the server device 301.

In operation 880, the server device 301 may identify whether the AR app performance evaluation score transferred from the electronic device 101 is higher than a threshold.

In operation 885, if the AR app performance evaluation score is lower than the threshold, the server device 301 may adjust (or tune) the performance preset previously transferred to the electronic device 101, thereby generating a personalized performance preset.

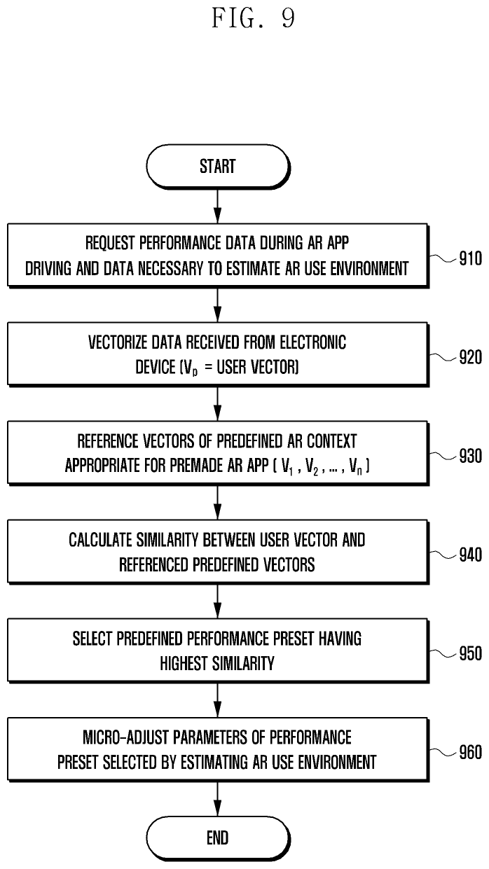

According to an embodiment, if the AR app performance evaluation score transferred from the electronic device is lower than the threshold, perform processes for generating a personalized performance preset in response to the situation of the electronic device 101 requested. The processes for generating a personalized performance preset will be described later with reference to FIG. 9.

In operation 887, the server device 301 may transfer the personalized performance preset to the electronic device 101.

In operation 890, the processor 120 of the electronic device 101 may apply the personalized performance preset transferred from the server device 301, thereby optimizing the AR service.

FIG. 9 is a flowchart illustrating an example personalized performance preset tuning method according to various embodiments.

Referring to FIG. 9, according to an embodiment, an electronic device (for example, the electronic device 101 in FIG. 1) or a server device (for example, the server device 301 in FIG. 6) may acquire device performance data (for example, first device performance data, second device performance data) and AR use environment data during AR app execution in operation 910.

In operation 920, the electronic device 101 or server device 301 may vectorize the electronic device's device performance data and AR use environment data. For example, Vp may refer to a user vector.

The electronic device 101 or server device 301 may index performance evaluation factors among the device performance data and AR use environment data. The performance evaluation factors may include, for example, at least one of rendering FPS, rendered image to display latency, head tracking latency, hand tracking latency, eye tracking latency, scene understanding latency, head tracking accuracy, hand tracking accuracy, eye tracking accuracy, scene understanding accuracy, GPU load, CPU load, power consumption, and temperature, but are not limited thereto.

In operation 930, the electronic device 101 or server device 301 may reference vectors (for example, V₁, V₂, . . . . Vₙ) of predefined AR context appropriate for an AR app implemented in advance. For example, the electronic device 101 or server device 301 may reference vectors or AR context in the database of a server device supporting an AR app service.

In operation 940, the electronic device 101 or server device 301 may calculate similarity by comparing the user vector collected in the electronic device and the referenced vectors.

As an example, the electronic device 101 or server device 301 may make comparison by calculating the similarity between the user vector and the referenced vectors (for example, similarity (Vₚ, V₁), similarity (Vₚ, V₂), . . . similarity (Vₚ, Vₙ)).

In operation 950, the electronic device 101 or server device 301 may select a predefined performance preset (for example, basic performance preset) in response to AR context having the highest similarity as a result of comparison.

In operation 960, the electronic device 101 or server device 301 may micro-adjust parameters of the performance preset selected by estimating the AR use environment, based on the selected performance preset, thereby generating a personalized performance preset.

For example, if the periphery of the AR app use environment (or driving environment) is in summer or has a temperature higher than the average temperature, the electronic device 101 or server device 301 may micro-adjust the heating management parameter, or may micro-adjust parameters related to allocation of other processing resources executed simultaneously with the AR app.

According to various example embodiments, a method for optimizing an augmented reality service by an electronic device may include: connecting to an augmented reality (AR) device, receiving a basic performance preset including an inter-device load balancing policy and a configuration parameter related to AR jobs based on providing an AR service by connecting to the AR device, performing inter-device load balancing such that the AR jobs are processed in a distributed manner in the AR device and the electronic device according to processing entities of respective AR jobs, based on the basic performance preset, based on an inter-device load balancing changing condition occurring to one of AR jobs currently processed in the AR device, reconfiguring a first AR job to which the changing condition occurred, among the AR jobs currently processed in the AR device, so as to be switched and processed in the electronic device, and receiving data related to the first AR job from the AR device and process the data.

According to various example embodiments, the AR jobs may include at least one of a head tracking job, a hand tracking job, an eye tracking job, and a scene analysis (for example, scene understanding) or rendering job.

According to various example embodiments, the reconfiguring a first AR job to which the changing condition occurred, among the AR jobs currently processed in the AR device, so as to be switched and processed in the electronic device may further include collecting first device performance data and AR use environment data through a sensor module of the electronic device, while performing the AR service, receiving second device performance data from the AR device, and monitoring whether the load balancing changing condition is changed with regard to the AR jobs, based on the first device performance data, the second device performance data, and the AR use environment data.

According to various example embodiments, the first device performance data may include at least one of the electronic device's GPU clock and CPU load, the electronic device's GPU clock and GPU load, the network type, the type of a tethering network between electronic device and the AR device, tethering network signal intensity, rendering frame per second (FPS), the electronic device's surface temperature, the electronic device's limit temperature, and electronic device resolution. The second device performance data may include at least one of the AR device's GPU clock and CPU load, the AR device's GPU clock and GPU load, the AR device's display frequency, the AR device's operating temperature, the AR device's refresh rate, the AR device's screen brightness, the AR device's limit temperature, network traffic, tracking frequency, tracking coordinates, tracking latency or tracking accuracy, tracking input image quality, scene analysis result, and scene analysis accuracy. The AR use environment data may include at least one of the electronic device's position information and the AR device's position information (for example, GPS-based position information, GEO IP-based position information), error process information during an AR service, AR app use time, and peripheral environment information.

According to various example embodiments, the method may further include, based on receiving data related to the first AR job from the AR device and processing the data, an operation of, based on a change return condition occurring to the first AR job currently processed in the electronic device, reconfiguring the first AR job so as to be processed in the AR device again.

According to various example embodiments, the method may further include estimating AR context corresponding to a current situation, based on a combination of the electronic device, the AR device, and an AR app, generating a personalized performance preset by adjusting at least a part of configuration parameters of the basic performance preset according to AR context estimated based on the first device performance data, the second device performance data, and the AR use environment data, and an operation of applying the generated personalized performance preset to the AR service.

According to various example embodiments, in the performing inter-device load balancing, personalized performance preset is applied such that the AR jobs are processed in a distributed manner in the AR device and the electronic device.

According to various example embodiments, in the receiving a basic performance preset, the electronic device's attribute information, the AR device's attribute information, and an AR app's attribute information may be transmitted to the server device through the communication module, and a basic performance preset appropriate for a combination of at least one of the electronic device, the AR device, and the AR app may be received from the server device.

According to various example embodiments, in the receiving a personalized performance preset, the first device performance data, the second device performance data, and the AR use environment data may be transmitted to the server device, and a personalized performance preset appropriate for a combination of the first device performance data, the second device performance data, and the AR use environment data may be received from the server device.

According to various example embodiments, the receiving a personalized performance preset may further include communicating with the server device so as to classify the first device performance data, the second device performance data, and the AR use environment data into data for performance evaluation, calculating a performance evaluation score with regard to each AR performance evaluation factor, based on the classified data, and an operation of selecting at least one first parameter requiring micro-adjustment among configuration parameters included in the basic performance preset, based on the performance evaluation score. The personalized performance parameter may be generated by micro-adjusting the selected at least one first parameter.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a communication module comprising communication circuitry; and
at least one processor, comprising processing circuitry,
memory storing instructions that, when executable by at least one the processor individually or collectively, cause the electronic device to:
connect to an augmented reality (AR) device through the communication module so as to receive a basic performance preset comprising an inter-device load balancing policy and a configuration parameter related to AR jobs based on providing an AR service;
perform inter-device load balancing such that the AR jobs are processed in a distributed manner in the AR device and the electronic device according to processing entities of respective AR jobs, based on the basic performance preset;
based on an inter-device load balancing changing condition occurring to one of AR jobs currently processed in the AR device, reconfigure a first AR job to which the changing condition occurred, among the AR jobs currently processed in the AR device, so as to be switched and processed in the electronic device; and
receive data related to the first AR job from the AR device and process the data.

2. The electronic device of claim 1, wherein the AR jobs comprise at least one of a head tracking job, a hand tracking job, an eye tracking job, and a scene analysis or rendering job.

3. The electronic device of claim 1, further comprising a sensor module, comprising at least one sensor,
wherein the instructions cause the electronic device to:
collect first device performance data and AR use environment data through the sensor module, while performing the AR service, and receive second device performance data from the AR device; and
monitor whether the load balancing changing condition is changed with regard to at least one of the AR jobs, based on the first device performance data, the second device performance data, and the AR use environment data.

4. The electronic device of claim 3, wherein the first device performance data comprises at least one of the electronic device GPU clock and CPU load, the electronic device GPU clock and GPU load, the network type, the type of a tethering network between electronic device and the AR device, tethering network signal intensity, rendering frame per second (FPS), the electronic device surface temperature, the electronic device limit temperature, and electronic device resolution,
wherein the second device performance data comprises at least one of the AR device GPU clock and CPU load, the AR device GPU clock and GPU load, the AR device display frequency, the AR device operating temperature, the AR device refresh rate, the AR device screen brightness, the AR device limit temperature, network traffic, tracking frequency, tracking coordinates, tracking latency or tracking accuracy, tracking input image quality, scene analysis result, and scene analysis accuracy, and
wherein the AR use environment data comprises at least one of the electronic device position information and the AR device position information, error process information during an AR service, AR app use time, and peripheral environment information.

5. The electronic device of claim 3, wherein the instructions cause the electronic device to:
based on a change return condition occurring to the first AR job currently processed in the electronic device, reconfigure the first AR job so as to be processed in the AR device again; and
transfer data related to the currently processed first AR job to the AR device.

6. The electronic device of claim 3, wherein the instructions cause the electronic device to:
estimate AR context corresponding to a current situation, based on a combination of the electronic device, the AR device, and an AR app;
perform performance evaluation corresponding to the estimated AR context, based on the first device performance data, the second device performance data, and the AR use environment data, and generate a personalized performance preset by adjusting at least a part of configuration parameters of the basic performance preset, based on the performance evaluation result; and
apply the generated personalized performance preset to the AR service.

7. The electronic device of claim 3, wherein the communication module is connected to a server, and
wherein the instructions cause the electronic device to: perform control such that the electronic device attribute information, the AR device attribute information, and an AR app attribute information are transmitted to the server device through the communication module, and a basic performance preset appropriate for a combination of at least one of the electronic device, the AR device, and the AR app is received from the server device.

8. The electronic device of claim 7, wherein the instructions cause the electronic device to:
control the electronic device to transmit the first device performance data, the second device performance data, and the AR use environment data to the server device; and
receive a personalized performance preset appropriate for a combination of the first device performance data, the second device performance data, and the AR use environment data from the server device.

9. The electronic device of claim 3, wherein the instructions cause the electronic device to:
communicate with the server device through the communication module so as to classify the first device performance data, the second device performance data, and the AR use environment data into data for performance evaluation, calculate a performance evaluation score with regard to each AR performance evaluation factor, select at least one first parameter requiring micro-adjustment among configuration parameters included in the basic performance preset, based on the performance evaluation score, and generate the personalized performance parameter by micro-adjusting the selected at least one first parameter.

10. A method for optimizing an augmented reality service by an electronic device, the method comprising:
connecting to an augmented reality (AR) device;
receiving a basic performance preset comprising an inter-device load balancing policy and a configuration parameter related to AR jobs when providing an AR service by connecting to the AR device;
performing inter-device load balancing such that the AR jobs are processed in a distributed manner in the AR device and the electronic device according to processing entities of respective AR jobs, based on the basic performance preset;
based on an inter-device load balancing changing condition occurring to one of AR jobs currently processed in the AR device, reconfiguring a first AR job to which the changing condition occurred, among the AR jobs currently processed in the AR device, so as to be switched and processed in the electronic device; and
receiving data related to the first AR job from the AR device and process the data.

11. The method of claim 10, wherein the reconfiguring of a first AR job to which the changing condition occurred, among the AR jobs currently processed in the AR device, so as to be switched and processed in the electronic device further comprises:
collecting first device performance data and AR use environment data through a sensor module of the electronic device, while performing the AR service;
receiving second device performance data from the AR device; and
monitoring whether the load balancing changing condition is changed with regard to the AR jobs, based on the first device performance data, the second device performance data, and the AR use environment data.

12. The method of claim 11, wherein the first device performance data comprises at least one of the electronic device GPU clock and CPU load, the electronic device GPU clock and GPU load, the network type, the type of a tethering network between electronic device and the AR device, tethering network signal intensity, rendering frame per second (FPS), the electronic device's surface temperature, the electronic device's limit temperature, and electronic device resolution,
wherein the second device performance data comprises at least one of the AR device GPU clock and CPU load, the AR device GPU clock and GPU load, the AR device display frequency, the AR device operating temperature, the AR device refresh rate, the AR device screen brightness, the AR device limit temperature, network traffic, tracking frequency, tracking coordinates, tracking latency and/or tracking accuracy, tracking input image quality, scene analysis result, and scene analysis accuracy, and
wherein the AR use environment data comprises at least one of the electronic device position information and the AR device position information, error process information during an AR service, AR app use time, and peripheral environment information.

13. The method of claim 11, further comprising, based on the receiving of data related to the first AR job from the AR device and processing of the data:
based on a change return condition occurring to the first AR job currently processed in the electronic device, reconfiguring the first AR job so as to be processed in the AR device again; and
transferring data related to the currently processed first AR job to the AR device.

14. The method of claim 11, further comprising:
estimating AR context corresponding to a current situation, based on a combination of the electronic device, the AR device, and an AR app;
generating a personalized performance preset by adjusting at least a part of configuration parameters of the basic performance preset according to AR context estimated based on the first device performance data, the second device performance data, and the AR use environment data; and
applying the generated personalized performance preset to the AR service.

15. The method of claim 10, wherein, in the receiving of a basic performance preset, the electronic device attribute information, the AR device attribute information, and an AR app attribute information are transmitted to the server device through the communication module, and a basic performance preset appropriate for a combination of at least one of the electronic device, the AR device, and the AR app is received from the server device, and
wherein the generating of a personalized performance preset further comprises:
communicating with the server so as to classify the first device performance data, the second device performance data, and the AR use environment data into data for performance evaluation;
calculating a performance evaluation score with regard to each AR performance evaluation factor, based on the classified data; and
selecting at least one first parameter requiring micro-adjustment among configuration parameters included in the basic performance preset, based on the performance evaluation score, and
wherein the personalized performance parameter is generated by micro-adjusting the selected at least one first parameter.
